(19) United States
(12) Patent Application Publication
(10) Pub. No.: US 2025/0113234 A1
(43) Pub. Date: Apr. 3, 2025

(54) INTER-TECHNOLOGY AND INTER-FREQUENCY MACHINE LEARNING-PROPAGATION SYSTEMS AND METHODS

(71) Applicant: Ekahau, Inc., New York, NY (US)

(72) Inventors: Olli Alanen, Helsinki (FI); Teemu Pulkkinen, Helsinki (FI); Janne Kurjenniemi, Jyväskylä (FI)

(73) Assignee: Ekahau, Inc., New York, NY (US)

(21) Appl. No.: 18/888,566

(22) Filed: Sep. 18, 2024

Related U.S. Application Data
(63) Continuation-in-part of application No. 18/375,399, filed on Sep. 29, 2023.

(51) Int. Cl. H04W 24/10; H04B 17/318; H04B 17/391

(52) U.S. Cl. CPC H04W 24/10; H04B 17/328; H04B 17/3913

(57) ABSTRACT

The devices, systems, and methods described herein are directed to using data associated with a wireless network operational area to train a machine learning model, where the data includes one or more signal characteristic measurement values. The trained machine learning model is used to build a signal propagation model for the wireless network operational area. In some examples, the machine learning model is trained based on signals transmitted in accordance with a first radio access technology (RAT), and the signal propagation model is built for signals transmitted in accordance with a second RAT using the trained machine learning model. In further examples, the machine learning model is trained based on signals transmitted within a first set of frequency bands, and the signal propagation model is built for signals to be transmitted over a second set of frequency bands using the trained machine learning model.

### CLAIM OF PRIORITY

The present application is a continuation-in-part of and claims priority to U.S. patent application Ser. No. 18/375,399, entitled “DEVICES, SYSTEMS, AND METHODS TO OPTIMIZE WIRELESS NETWORKS” and filed Sep. 29, 2023, which is assigned to the assignee hereof and hereby expressly incorporated by reference in its entirety.

### FIELD

The subject matter described herein relates to devices, systems, and methods for configuring wireless networks and more particularly to building a signal propagation model using a trained machine learning model.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices.

### SUMMARY

The devices, systems, and methods described herein are directed to using data associated with a wireless network operational area to train a machine learning model, where the data includes one or more signal characteristic measurement values. The trained machine learning model is used to build a signal propagation model for the wireless network operational area. In some examples, the machine learning model is trained based on signals transmitted in accordance with a first radio access technology (RAT), and the signal propagation model is built for signals transmitted in accordance with a second RAT using the trained machine learning model. In further examples, the machine learning model is trained based on signals transmitted within a first set of frequency bands, and the signal propagation model is built for signals to be transmitted over a second set of frequency bands using the trained machine learning model.

### BRIEF DESCRIPTION OF THE DRAWINGS

FIG. 1 is a block diagram of an example of a wireless network optimization system in which a local computing device trains a machine learning model and builds a signal propagation model using the trained machine learning model.

FIG. 2 is a block diagram of an example of a wireless network optimization system in which a remote computing device trains a machine learning model and builds a signal propagation model using the trained machine learning model.

FIG. 3 is a flow chart of an example of a method for optimizing a wireless network in which a machine learning model is trained and a signal propagation model is built using the trained machine learning model.

FIG. 4 is a block diagram of an example of the measurement device shown in FIG. 1.

FIG. 5 is a flow chart of an example of a method in which a machine learning model is trained based on signal characteristic measurement values associated with signals transmitted in accordance with a first radio access technology (RAT), and a signal propagation model is built for signals transmitted in accordance with a second RAT using the trained machine learning model.

### DETAILED DESCRIPTION

Wi-Fi radio bands have relatively high absorption and work best for line-of-sight use. Many common obstructions such as walls, floors, ceilings, pillars, doors, electronic devices, and appliances may interfere with signal propagation through a network operational area, which reduces the effective range of the Wi-Fi network. For example, a Wi-Fi access point range is about 20 m (66 ft) indoors, while the access point range may be as high as 150 m (490 ft) outdoors.

Since Wi-Fi networks are very widely deployed in different environments, one of the most important use cases is the optimization of the performance and capacity of the existing networks. In order to optimize network performance, some existing solutions require detailed measurements of the network operational area, calibration of wall attenuation values, special network planning expertise, and a large amount of manual work to properly analyze, evaluate, and configure existing networks.

For example, some existing solutions require manual configuration of the floor plan in the network operational area. The first step of this type of manual optimization is to define the physical environment. This requires that the user uploads the floor plan and manually inserts any physical obstacles, such as walls, doors, windows, and large furniture into the floor plan. Some of the information, such as wall positions, may be read from digital floor plans, but some information must be inserted manually. In the event that digital floor plans are not available, all obstacles are required to be manually inserted into the floor plan, which is time consuming, inefficient, and lends itself to errors if the user enters incorrect information regarding the obstacles in the network operational area.

The challenges of properly entering the floor plan are compounded when the network operational area involves multiple floors within a building. For example, in multi-floor buildings there are separate floor plans for each floor. Thus, additional manual work is required to correctly position floor plans for each of the different floors on top of each other and with the correct orientation. This problem can be exacerbated when the floor plan images available to a user have scaling or orientation that is not the same for each floor.

Another significant challenge to optimizing Wi-Fi networks with existing solutions is the difficulty in properly calibrating the radio frequency (RF) environment. For example, modeling existing networks with current solutions is labor intensive and time consuming. Accurate manual network planning takes a long time because it is not possible to know how structures, such as walls, doors, shelves, and furniture, will attenuate RF signals without actually measuring the attenuation. In order to determine an accurate attenuation value, each of the structures in the network operational area should be separately measured. Once the attenuation values are known, the user needs to configure the corresponding value to the network plan in the planning tool. However, even if all the structures are separately measured, the propagation calculation would still rely on the theoretical free space path loss (FSPL) model, which is a good estimation in open spaces, but it does not account for the attenuation caused by obstacles or building structures.

Besides the foregoing challenges, it can be difficult to manually define the requirement area, according to existing network planning solutions. In this regard, the goal of defining the requirement area is that coverage will be planned for the defined requirement area. However, in some cases, the requirement area is not defined at all, or survey measurements are not done for the entire requirement area. Both of these cases lead to problems in evaluating network performance since there is a mismatch between the intended requirement area and the planned network.

Existing solutions also require a high level of domain area expertise. For example, the RF environment within the network operational area can frequently change and, therefore, needs to be frequently measured and optimized. Such optimization of the existing Wi-Fi network requires a high level of domain area expertise. Users that are maintaining existing networks are not typically RF experts, which means that they need to find expensive external help when the network is not performing properly.

Additionally, the required quality of the survey performed in the network operational area is not clearly defined and can vary depending on the needs of the owner/operator of the wireless network. Good practice is that there should be survey measurements in every room/floor of the network operational area. In existing solutions, survey measurements are accurate in the proximity of the survey path, but the accuracy of the survey measurements decreases as the distance from the survey path increases.

Even if all the foregoing issues are addressed, it is not easy to propose a new network configuration, which may require moving one or more access points to a new location or predicting signal propagation characteristics for one or more newly added access points.

The devices, systems, and methods described herein are directed to using data associated with a wireless network operational area to train a machine learning model, where the data includes one or more signal characteristic measurement values. The trained machine learning model is used to build a signal propagation model for the wireless network operational area. In some examples, the signal propagation model may be used to generate a network performance visualization or a heatmap of the wireless network operational area. In further examples, the system may generate one or more recommendations to optimize one or more performance indicators of the wireless network.

Although the different examples of devices, systems, and methods described herein may be discussed separately, any of the features of any of the examples may be added to, omitted from, or combined with any other example. Similarly, any of the features of any of the examples may be performed in parallel or performed in a different manner/order than that described or shown herein.

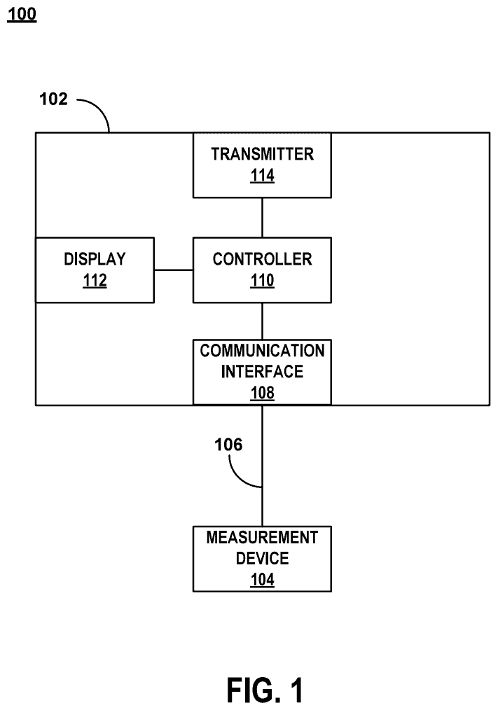

FIG. 1 is a block diagram of an example of a wireless network optimization system in which a local computing device trains a machine learning model and builds a signal propagation model using the trained machine learning model. In the example shown in FIG. 1, wireless network optimization system 100 includes local computing device 102. In some examples, local computing device 102 can be any on-site computing device that can receive and process data associated with a wireless network operational area. For example, local computing device 102 could be a tablet computer, a laptop computer, a smartphone, or a desktop computer.

Wireless network optimization system 100 includes communication interface 108, controller 110, display 112, and transmitter 114 of local computing device 102. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

In the example shown in FIG. 1, measurement device 104 utilizes one or more Wi-Fi radios to receive Wi-Fi signals as a user moves measurement device 104 along a survey path within a wireless network operational area. In other examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

Measurement device 104 processes the received Wi-Fi signals to obtain data associated with the wireless network operational area. In some examples, the data includes one or more signal characteristic measurement values. For example, Received Signal Strength Indicator (RSSI) measurement values may be included in the data. Of course, any other suitable signal characteristics may be measured and included in the data associated with the wireless network operational area. For example, the signal characteristic measurement values may include other measurements of signal strength and/or quality. In some examples, the signal strength measurement may include a measurement of the multi-path properties and/or the phase of the received Wi-Fi signals. The data received from measurement device 104 may also include the location of wireless network access points and RF measurements taken at different locations in the wireless network operational area along a survey path, which is a route taken by a user through the wireless network operational area while carrying/moving measurement device 104 in order to obtain the data.

Measurement device 104 provides the data associated with the wireless network operational area to local computing device 102 via communication link 106. Local computing device 102 uses controller 110 to train a machine learning model, based at least partially on the data received from measurement device 104. Different machine learning methods, such as a gradient boosted random forest, could be used to train the machine learning model. In this manner, the machine learning model learns the different properties of the wireless network operational area (e.g., walls, other obstacles, overall building structure, and how signals propagate in that environment, including signal reflections and diffractions). In some examples, additional information could be used to train the machine learning model (e.g., the location of walls or other obstacles, transmit power settings of one or more of the access points, and the distance between an access point and the measurement device when measurements were taken during the survey).

Once the machine learning model is trained, controller 110 uses the trained machine learning model to build a signal propagation model for the wireless network operational area. The signal propagation model can estimate the signal propagation between any points in the wireless network operational area. This capability allows the system to simulate the effect of changing various network configurations (e.g., channel configurations, channel widths, or adjusting transmission power or disabling radios of one or more access points) or physical changes (e.g., adding a new access point or moving an existing access point to any other location in the wireless network operational area). Thus, the system can also utilize the signal propagation model to perform Leave-One-Radio-Out (LORO) testing to evaluate the effect of either removing a particular access point from the wireless network operational area or disabling the radio of that particular access point.

Controller 110 includes any combination of hardware, software, and/or firmware for executing the functions described herein. An example of a suitable controller 110 includes software code running on a microprocessor or processor arrangement connected to memory.

In some examples, controller 110 also generates one or more network performance visualizations, based on the signal propagation model. In other examples, controller 110 renders, based on the signal propagation model, a heatmap of the wireless network operational area. In these examples, the rendered heatmap is based on values of one or more performance indicators determined by the signal propagation model. In some examples, different heatmaps may be rendered for different Key Performance Indicators (KPIs) and utilized to propose recommendations for network optimization. These network optimization recommendations may include (1) coverage optimization by adjusting transmit powers, proposing new access points or new locations for existing access points, and/or (2) capacity optimization by reducing channel interference (e.g., by implementing a new channel plan or disabling interfering access points), proposing new access points, or proposing one or more other types of antennas to be used by one or more of the access points.

In any of these examples, display 112 may be used to display the performance visualizations and/or the heatmap to a user. In this manner, the user can easily see where the network operational area has varying degrees of signal strength/coverage.

In further examples, controller 110 generates one or more recommendations to optimize one or more performance indicators of the wireless network. In some examples, a performance indicator may be a signal-to-noise ratio (SNR). Of course, any other suitable performance indicator may be utilized, in other examples.

In still further examples, controller 110 estimates a location of one or more access points in the wireless network operational area, based at least partially on one or more Received Signal Strength Indicator (RSSI) measurements included in the data received from measurement device 104. In these examples, controller 110 trains the machine learning model, based at least partially on the estimated location of the one or more access points.

In some examples, controller 110 trains the machine learning model, based at least partially on a transmit power of one or more access points in the wireless network operational area. In some examples, an access point may indicate its transmission power in its beacon frames. In other examples, the transmission power may be estimated by measuring the received Wi-Fi signals.

In other examples, controller 110 trains the machine learning model, based at least partially on a distance of measurement device 104 from one or more access points in the wireless network operational area when the data is obtained. In some examples, a user may provide, to the system, the distance/location of the measurement device relative to one or more access points while receiving the Wi-Fi signals. In other examples, the measurement device is configured to automatically detect the distance/location of the measurement device relative to one or more access points while receiving the Wi-Fi signals. In these examples, the distance/location of the measurement device relative to the access point is automatically calculated once the location of the access point has been estimated.

In some examples, the signal propagation model covers a requirement area larger than a survey path along which the data is obtained. For example, although only measurements from the survey path are taken, training the machine learning model extends the propagation calculation to cover the full wireless network operational area beyond the survey path and allows generation of a heatmap for the full area, even in cases when the entire wireless network operational area is not fully covered by the survey.

In some examples, controller 110 may determine the boundaries of the requirement area, based at least partially on a convex hull of the data. In this regard, a convex hull of a set of points is understood to mean the smallest convex polygon that encloses all of the points in the set. Convex means that the polygon has no corner that is bent inwards. As used herein, a convex hull of the data refers to a convex hull of (1) all points at which signal measurements were taken during a survey of the wireless network operational area, (2) known or estimated access point locations, or (3) a combination of measurement locations and access point locations. Automatically defining the requirement area in this manner ensures that the requirement area corresponds with the survey measurements, and network performance evaluation can be done correctly.

In some examples, controller 110 may automatically generate a floor map of the wireless network operational area, based on the data received from measurement device 104. In other examples, a user may have the option of entering an existing floor map into local computing device 102, which will automatically detect walls from the entered floor map images. The wall information is then used by controller 110 to train the machine learning model.

In some examples, controller 110 determines, based at least partially on one or more Received Signal Strength Indicator (RSSI) measurements included in the data, a recommended arrangement and/or alignment of a plurality of floors of the wireless network operational area relative to each other. Thus, based on signal strength measurements, floor maps can be automatically arranged in correct order from the bottom floor to the top floor (e.g., in a z-coordinate) of the wireless network operational area. In some examples, the floor map alignment may also include aligning the floors in the x-y plane. In some examples, floor map alignment could also be automated with machine learning techniques (e.g., with image registration to find the optimal transformation (e.g., affine, rotate, shift, zoom etc.)) to maximize a certain metric (e.g., Intersection over Union, dice score, etc.) and align floor maps correctly on top of each other.

In some examples, the wireless network optimization system further comprises a display to display the recommended arrangement of the plurality of floors to a user for approval. Thus, even though automatic floor alignment would be possible in most cases, it would be advantageous to allow a user to approve, modify, or reject the recommended alignment/arrangement of floor maps.

In some examples, controller 110 estimates a quality of the data, based at least partially on a number and a quality of survey measurements taken when performing a survey of the wireless network operational area. Estimating the quality and the amount of survey measurements permits an estimate of the accuracy of the trained machine learning model.

In the example shown in FIG. 1, transmitter 114 includes electronics configured to transmit wired or wireless signals directly to another device or via a network. In some examples, transmitter 114 may include multiple transmitters. In some examples, transmitter 114 may be used to transmit information to a remote device (e.g., data received from measurement device 104, network performance visualizations, heatmaps, recommendations for network optimization, etc.).

The foregoing examples utilize machine learning techniques to automatically build a model of the wireless network operational area based on the survey measurements received from a measurement device. By training the machine learning model and utilizing the signal propagation model as described above, the system can generate automated network optimization recommendations to improve existing network performance, capacity, and coverage. Moreover, the foregoing examples eliminate the need for manual definition of the physical environment, eliminate the definition of attenuation values and wall calibration, eliminate manual planning and optimization, do not require special network planning expertise, and provide higher accuracy than currently used FSPL-based propagation models.

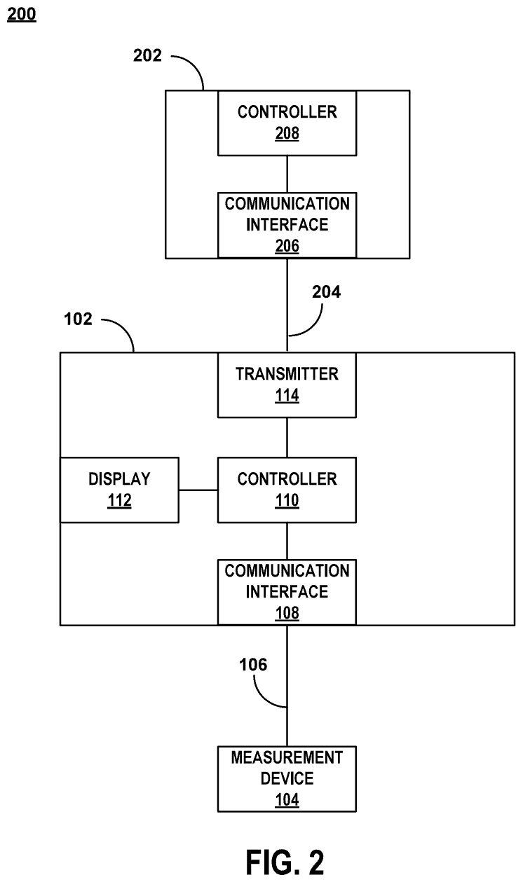

FIG. 2 is a block diagram of an example of a wireless network optimization system in which a remote computing device trains a machine learning model and builds a signal propagation model using the trained machine learning model. The example shown in FIG. 2 is similar to FIG. 1 except that, in system 200, local computing device 102 transmits, via transmitter 114, the data received from measurement device 104 to remote computing device 202 via communication link 204. In the example shown in FIG. 2, communication link 204 is at least partially wired (e.g., through a network). However, communication link 204 may be wireless, in other examples.

Remote computing device 202 receives the data via communication interface 206 and provides the data to controller 208, which trains the machine learning model and builds the signal propagation model, as described in connection with controller 110 of FIG. 1. In the example of FIG. 2, controller 208 also performs the additional functions described in connection with controller 110, including generating network performance visualizations, heatmaps, recommendations for network optimization, etc. Remote computing device 202 transmits the network performance visualizations, heatmaps, recommendations for network optimization, etc. to local computing device 102, via communication link 204, for presentation to a user.

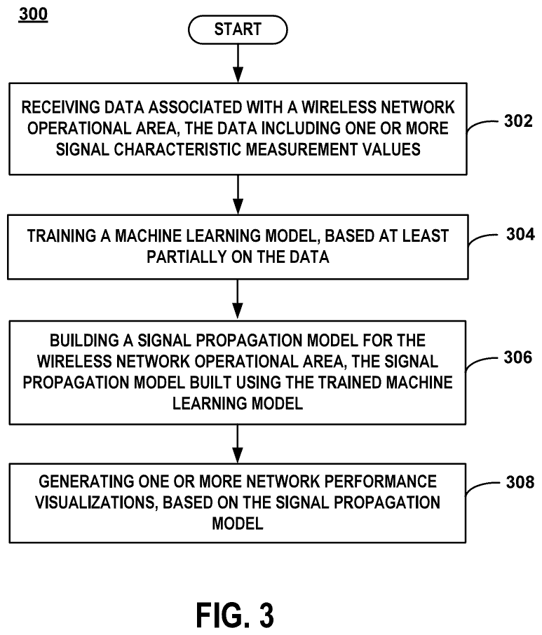

FIG. 3 is a flow chart of an example of a method for optimizing a wireless network in which a machine learning model is trained and a signal propagation model is built using the trained machine learning model. The method 300 begins at step 302 with receiving data associated with a wireless network operational area, where the data includes one or more signal characteristic measurement values. At step 304, a machine learning model is trained, based at least partially on the received data. At step 306, a signal propagation model is built for the wireless network operational area, where the signal propagation model is built using the trained machine learning model. At step 308, one or more network performance visualizations are generated, based on the signal propagation model. In other examples, one or more of the steps of method 300 may be omitted, combined, performed in parallel, or performed in a different order than that described herein or shown in FIG. 3. In still further examples, additional steps may be added to method 300 that are not explicitly described in connection with the example shown in FIG. 3.

In some of the following examples, the systems described herein may be utilized to take measurements of signals transmitted in accordance with a first radio access technology (RAT) and build a signal propagation model for signals transmitted in accordance with a second RAT, based on the measurements of the signals transmitted in accordance with the first RAT. In other examples, the systems described herein may be used to take measurements of signals transmitted within a first set of frequency bands and build a signal propagation model for signals to be transmitted over a second set of frequency bands, based on the measurements of the signals transmitted within the first set of frequency bands.

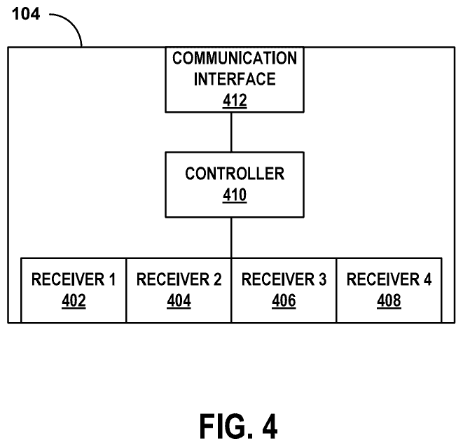

FIG. 4 is a block diagram of an example of the measurement device shown in FIG. 1. In the example shown in FIG. 4, measurement device 104 utilizes four receivers (e.g., receiver 1, 402; receiver 2, 404; receiver 3, 406; receiver 4, 408) to receive Wi-Fi signals from various nodes of a wireless network. In other examples, any other suitable number of receivers may be utilized in measurement device 104. Regardless of the number of receivers in measurement device 104, each receiver is capable of scanning and monitoring a set of Wi-Fi frequencies or frequency bands and capturing all Wi-Fi link layer frames (e.g., packets) being heard on those frequencies or frequency bands, in some examples.

In some examples, measurement device 104 utilizes its one or more receivers to carry out measurements on several frequencies or frequency bands simultaneously or nearly simultaneously. In other examples, a single Wi-Fi radio (e.g., receiver), module, or chipset can be configured to operate on the separate frequencies or frequency bands at the same time, which is referred to as a Dual Band Simultaneous (DBS) configuration. Thus, the functionality of the measurement device, as described herein, may be accomplished with a measurement device having multiple receivers or a single, properly configured receiver.

The measurement device 104 shown in FIG. 4 also includes controller 410, which processes the signals received by receivers 402, 404, 406, and 408. Controller 410 includes any combination of hardware, software, and/or firmware for executing the functions described herein. An example of a suitable controller 410 includes software code running on a microprocessor or processor arrangement connected to memory (not explicitly shown). It is worth noting that, in some examples, any of the functions described herein as being performed by controller 110 may be performed by controller 410, and vice versa.

Measurement device 104, as shown in FIG. 4, also includes communication interface 412, which measurement device 104 uses to communicate with local computing device 102 via communication link 106. In some examples, the communication between measurement device 104 and local computing device 102 includes providing data to local computing device 102 and receiving command instructions regarding which frequencies or frequency bands of a wireless network are selected for measurement. As will be discussed more fully below, based on which frequencies or frequency bands are selected for measurement, controller 410 can dynamically configure receivers 402, 404, 406, and 408 to measure signals received on particular frequencies or frequency bands, in some examples.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

In some examples, system 100 utilizes communication interface 108 to receive data associated with a wireless network operational area, where the data includes one or more signal characteristic measurement values associated with signals transmitted in accordance with a first RAT. In further examples, the data includes one or more of the following: measurement position, Received Signal Strength Indicator (RSSI), transmitter position, frequency, and transmitter configuration.

In still further examples, system 100 utilizes controller 110 to train a machine learning model, based at least partially on the data received via communication interface 108. In some examples, system 100 utilizes controller 110 to build a signal propagation model for signals transmitted in accordance with a second RAT in the wireless network operational area, where the signal propagation model is built using the trained machine learning model. In other examples, the signal propagation model can be used to predict any radio signal (1) at the area where the survey was performed, (2) for any transmitter position in the area, and/or (3) for any frequency that is between or near the measured frequencies. In further examples, controller 110 may configure a structure of a wireless network that operates in accordance with the second RAT in the wireless network operational area, based on the signal propagation model built for signals transmitted in accordance with the second RAT.

In some examples, the first RAT and the second RAT are different radio access technologies. In the examples in which the first RAT and the second RAT are different radio access technologies, the first RAT may be a Wi-Fi protocol, and the second RAT may be a cellular protocol. In other examples, the first RAT and the second RAT are the same radio access technology. In the examples in which the first RAT and the second RAT are the same radio access technology, the signals transmitted in accordance with the first RAT may be transmitted over a first frequency band or bands, and the signals transmitted in accordance with the second RAT may be transmitted over a second frequency band or bands different than the first frequency band or bands. One example in which the first RAT and the second RAT are the same radio access technology would include the scenario in which Wi-Fi measurements are taken on the 5 GHz frequency band and the signal propagation model is built for signals to be transmitted over the 6 GHz Wi-Fi frequency band.

In some examples, a measurement device such as measurement device 104 in FIG. 4 is utilized to receive signals. In these examples, the measurement device 104 comprises a plurality of receivers 402, 404, 406, and 408 to receive the signals transmitted in accordance with the first RAT, and two or more of the plurality of receivers receive the signals on different frequencies. In further examples, the measurement device 104 includes one or more signal characteristic measurement values of the signals received on the different frequencies in the data transmitted to the communication interface 108. In these examples, controller 410 may comprise frequency switching logic which dynamically controls the frequencies on which the plurality of receivers receive the signals. In some examples, the frequency switching logic may be configured to obtain measurements taken at the same position of the measurement device using different receivers on different frequencies, which may improve the ability of the machine learning training algorithm to learn the impact of the frequency or frequencies being measured. For example, a Wi-Fi access point may have 2.4 GHZ, 5 GHZ, and 6 GHz radios. The measurement device can configure the frequency switching logic such that it almost simultaneously measures the beacon RSSI on all three of the transmission frequencies, in some examples.

In other examples, measurements may be taken over multiple frequency bands (e.g., 2.4 GHz and 6 GHz Wi-Fi frequency bands), and the signal propagation model may be built for multiple frequency bands (e.g., 3.5 GHz cellular and 5 GHz Wi-Fi frequency bands). Of course, any other suitable number and combination of measurement frequency bands and signal propagation modelled frequency bands may be utilized, in other examples.

In further examples, controller 100 may map a first signal strength indicator associated with the signals transmitted in accordance with the first RAT to a second signal strength indicator associated with the signals transmitted in accordance with the second RAT. In these examples, the first signal strength indicator may be a Wi-Fi Received Signal Strength Indicator (RSSI), and the second signal strength indicator may be a cellular Reference Signal Received Power (RSRP).

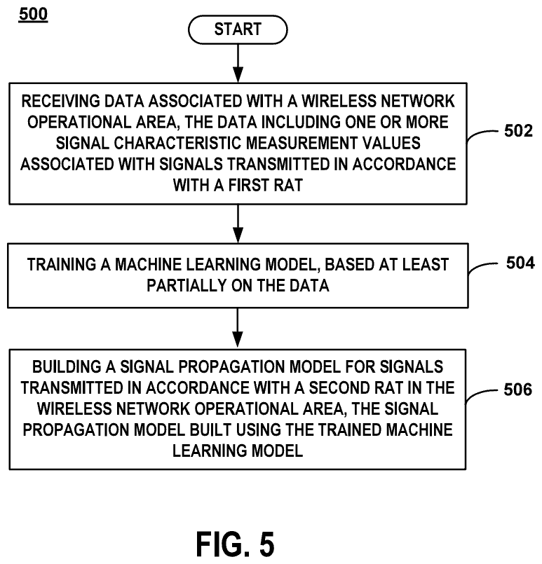

FIG. 5 is a flow chart of an example of a method in which a machine learning model is trained based on signal characteristic measurement values associated with signals transmitted in accordance with a first radio access technology (RAT), and a signal propagation model is built for signals transmitted in accordance with a second RAT using the trained machine learning model. The method 500 begins at step 502 with receiving data associated with a wireless network operational area, where the data includes one or more signal characteristic measurement values associated with signals transmitted in accordance with a first RAT. At step 504, a machine learning model is trained, based at least partially on the received data. At step 506, a signal propagation model is built for signals transmitted in accordance with a second RAT in the wireless network operational area, where the signal propagation model is built using the trained machine learning model.

In other examples, one or more of the steps of method 500 may be omitted, combined, performed in parallel, or performed in a different order than that described herein or shown in FIG. 5. In further examples, additional steps may be added to method 500 that are not explicitly described in connection with the example shown in FIG. 5. For example, the method may also include (1) receiving, with a measurement device comprising a plurality of receivers, the signals transmitted in accordance with the first RAT, where two or more of the plurality of receivers receive the signals on different frequencies, and (2) including one or more signal characteristic measurement values of the signals received on the different frequencies in the data associated with the wireless network operational area. In the examples in which the signals are received on different frequencies, the method may additionally include dynamically controlling the frequencies on which the plurality of receivers receive the signals. In other examples, the method may further include mapping a first signal strength indicator associated with the signals transmitted in accordance with the first RAT to a second signal strength indicator associated with the signals transmitted in accordance with the second RAT. In further examples, the method may also include configuring a structure of a wireless network that operates in accordance with the second RAT in the wireless network operational area, based on the signal propagation model built for signals transmitted in accordance with the second RAT.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A system comprising:
a communication interface to receive data associated with a wireless network operational area, the data including one or more signal characteristic measurement values associated with signals transmitted in accordance with a first radio access technology (RAT); and
a controller to:
train a machine learning model, based at least partially on the data, and
build a signal propagation model for signals transmitted in accordance with a second RAT in the wireless network operational area, the signal propagation model built using the trained machine learning model.

2. The system of claim 1, wherein the first RAT and the second RAT are different radio access technologies.

3. The system of claim 2, wherein the first RAT is a Wi-Fi protocol and the second RAT is a cellular protocol.

4. The system of claim 1, wherein the first RAT and the second RAT are a same radio access technology, the signals transmitted in accordance with the first RAT being transmitted over a first frequency band and the signals transmitted in accordance with the second RAT being transmitted over a second frequency band different than the first frequency band.

5. The system of claim 1, further comprising:
a measurement device comprising a plurality of receivers to receive the signals transmitted in accordance with the first RAT, two or more of the plurality of receivers to receive the signals on different frequencies, the measurement device to include one or more signal characteristic measurement values of the signals received on the different frequencies in the data transmitted to the communication interface.

6. The system of claim 5, wherein the controller comprises frequency switching logic which dynamically controls the frequencies on which the plurality of receivers receive the signals.

7. The system of claim 1, wherein the controller further maps a first signal strength indicator associated with the signals transmitted in accordance with the first RAT to a second signal strength indicator associated with the signals transmitted in accordance with the second RAT.

8. The system of claim 7, wherein the first signal strength indicator is a Wi-Fi Received Signal Strength Indicator (RSSI) and the second signal strength indicator is a cellular Reference Signal Received Power (RSRP).

9. The system of claim 1, wherein the controller further configures a structure of a wireless network that operates in accordance with the second RAT in the wireless network operational area, based on the signal propagation model built for signals transmitted in accordance with the second RAT.

10. A method comprising:
receiving data associated with a wireless network operational area, the data including one or more signal characteristic measurement values associated with signals transmitted in accordance with a first radio access technology (RAT);
training a machine learning model, based at least partially on the data; and
building a signal propagation model for signals transmitted in accordance with a second RAT in the wireless network operational area, the signal propagation model built using the trained machine learning model.

11. The method of claim 10, wherein the first RAT and the second RAT are different radio access technologies.

12. The method of claim 11, wherein the first RAT is a Wi-Fi protocol and the second RAT is a cellular protocol.

13. The method of claim 10, wherein the first RAT and the second RAT are a same radio access technology, the signals transmitted in accordance with the first RAT being transmitted over a first frequency band and the signals transmitted in accordance with the second RAT being transmitted over a second frequency band different than the first frequency band.

14. The method of claim 10, further comprising:
receiving, with a measurement device comprising a plurality of receivers, the signals transmitted in accordance with the first RAT, two or more of the plurality of receivers to receive the signals on different frequencies; and
including one or more signal characteristic measurement values of the signals received on the different frequencies in the data associated with the wireless network operational area.

15. The method of claim 14, further comprising:
dynamically controlling the frequencies on which the plurality of receivers receive the signals.

16. The method of claim 10, further comprising:
mapping a first signal strength indicator associated with the signals transmitted in accordance with the first RAT to a second signal strength indicator associated with the signals transmitted in accordance with the second RAT.

17. The method of claim 16, wherein the first signal strength indicator is a Wi-Fi Received Signal Strength Indicator (RSSI) and the second signal strength indicator is a cellular Reference Signal Received Power (RSRP).

18. The method of claim 10, further comprising:
configuring a structure of a wireless network that operates in accordance with the second RAT in the wireless network operational area, based on the signal propagation model built for signals transmitted in accordance with the second RAT.
